(19) United States
(12) Patent Application Publication
(10) Pub. No.: US 2011/0178209 A1
(43) Pub. Date: Jul. 21, 2011

(54) MANUFACTURING HYDRAULIC CEMENT AGGREGATES FOR USE IN INSULATING AND HEAT REFLECTING PRODUCTS

(76) Inventor: Ashok Anant Ganpule, Ahmedabad (IN)

(21) Appl. No.: 13/119,550

(22) PCT Filed: Sep. 18, 2009
(86) PCT No.: PCT/IN2009/000514

§ 371 Date: Mar. 17, 2011

(30) Foreign Application Priority Data
Sep. 19, 2008 (IN) 2013/MUM/2008

(51) Int. Cl. C04B 24/26

(52) U.S. Cl. 524/5; 524/2; 524/8

(57) ABSTRACT

Insulation and heat resistance hydraulic cement aggregates comprising of white Portland cement, with or without additives and filler, magnesium oxide, zirconium compounds, marble, dolomite, granite, sand, talc, clays calcined, boron compounds, silicates, trap rock aggregate, polymeric binder/s optionally water.

### FIELD OF THE INVENTION

The invention relates to thermal insulation compositions. Present invention is more particularly relates to thermal insulation compositions to containing improved hydraulic cement. Further invention also relates to the method of manufacturing of containing improved hydraulic cement composition.

### PRIOR ART

In prior art, there are available insulating and heat reflecting materials such as, thermocole, polysterine etc. Also there are paints which can be used for reflecting heat from the surface. These materials are porous and weak. It is the matter of fact that these insulating and heat reflecting materials cannot be used under load.

The coatings are made of heat reflective materials. The coatings are very thin and the normal thickness is 1 to 3 mm. The bond strength of the coatings is low and they tend to wear off after some time. The surface cannot be properly cleaned. Dirt tends to collect on the surface and thus reducing the efficiency.

Moreover, the coatings formed by the paints, polymers on the surface of the substrate are not durable and chemical resistance.

It is also known in the prior art to use a variety of additives are incorporated in the cement compositions to strengthen the desired properties of cement, mortar and concrete. Often these are used in various combinations. Some of these components are silicates, aluminates, minerals, organic polymers.

For example, U.S. Pat. No. 4,249,948 disclosed the use of an alpha olefin sulfonate with a water reducing agent wherein the former acts as an air-entraining agent in a hydraulic cement composition.

JP-01061369A2 teaches about heat insulating concrete panel—includes specified amts. of white aggregate and lightweight aggregate and how to improves properties related excellent light-resistance, weather-resistance and mechanical strength and minimized surface temperature rise caused by direct sunlight, by shot-blasting the surface of a specific flat concrete plate, thereby roughening the surface.

CN1152601 discloses a thermal insulation water-proof paste and its production, which comprises base material made form calcium carbonate and silicates and mineral powders.

CN 1390801 discloses an elastic water-proof material for cement and its production, which is composed of organic components and inorganic components, organic components are acrylic acid emulsion, ethylene vinyl acetate copolymers emulsion, polyvinyl alcohol as modifies for stabilizing emulsion.

WO93/04007A discloses a water resistance building material comprising gypsum, water proof agent such as silicone emulsion, PVA, paraffin wax emulsion and the like fly ash, Portland cement, fibrous reinforcement and water perlite.

### OBJECT OF THE INVENTION

Object of the invention is to develop thermal insulation or heat resistance compositions comprising hydraulic cement.

Another object of the invention is to improve thermal insulation or heat resistance properties of the hydraulic cement.

Yet, another object of the invention is to manufacture thermal insulation or heat resistance hydraulic cement composition with enhanced thermal insulation properties.

Yet, another object of the invention is to manufacture pre-casted articles having thermal insulation or heat resistance properties prepared form the improved hydraulic cement composition.

Yet, another object of the invention is to manufacture hydraulic cement aggregate consisting of Tiles, Blocks, Mortars, loose fill materials, paints and coatings, wall plasters, cement sheets, porous materials, joint fillers,

Yet, another object of the invention is to develop method for manufacture for thermal insulation or heat resistance hydraulic cement composition.

### BRIEF DESCRIPTION OF THE INVENTION

The present invention is relates to hydraulic cement composition. The hydraulic cement composition having enhanced heat resistance or thermal insulation properties. The heat resistance properties of the hydraulic cement are improved by adding heat absorbing or reflecting materials. Further present invention comprises of adding Hydrolyzed hydraulic white cement aggregate or powder to which a heat resistance material/s is added to form the required shape of insulating and heat reflecting products. The said aggregate consisting of materials added before or after hydrolization to induce additional properties prior to or after hydrolization and making the aggregate. The binder consists of hydraulic cements, air setting cements, organic binders. The products manufactured using different grain sizes of the aggregate. The products containing at least one component as the cement aggregate.

The other filler materials consisting of Al₂O₃, MgO, Zirconium, Titania, Talc, Mica based compounds and other inorganic materials.

Products manufactured using cement aggregate consisting of Tiles, Stocks, Mortars, loose fill materials, paints and coatings, wall plasters, cement sheets, porous materials, joint fillers and additives.

### DETAILED DESCRIPTION OF THE INVENTION

The present invention concerns a chemical additive for combining into hydraulic cement mixes with binder consists of hydraulic cements, air setting cements organic binders, filer materials such as of Al₂O₃, MgO, Zirconium, Titania, Talc, Mica based compounds and other inorganic materials. Resulting improved mixes for incorporating an additive composition.

For purposes of this invention the term “hydraulic cement” refers to all cementitious compositions based primarily on silicates capable of being set and hardened by the action of water, such as Portland cements, sulfate-resisting cement, blast furnace cements and pozzolanic cements, including cement mixes where a portion of the Portland cement has been replaced by fly ash or slag. The term “Portland cement” refers to all cementitious compositions which have a high content of tricalcium silicate, conforming to the specifications set forth in ASTM designation no. C-150, and the Portland blended cements such as those described in ASTM designation No. C-595. Broadly, the invention comprises a Portland cement mix including fly ash and/or slag cement, aggregate, sufficient water to effect hydraulic setting of the cement, and an air-entraining additive

According to present invention filers are the alumina (Al2O3) hydrated Aluminium Oxide and aluminum bearing compounds, it is resistant to sulfates. It can withstand high temperatures. (It melts at around 3000 F.)

Magnesium oxide, or magnesia, is a white solid mineral Portland cement magnesium oxide and magnesium chloride based cements, Portland cement Magnesium-based cements commonly achieve compressive strengths of 9,000 to 45,000 psi and tension strength of over 800 psi, many times stronger than that of conventional concrete. Magnesium oxide combined with clays and cellulose form cements that breathe water. The clay in magnesium oxide balances and enhances the movement of moisture. It never rots because it always expels moisture.

According to present invention of zirconium compounds are used as such as zirconium dioxide used in refractories for high-temperature applications brings to the fore the need for a suitable mortar. The zirconium compounds give heat resistance properties to the hydraulic cement compositions, it is known in the art to produce zirconia from zirconium sulphate solution by precipitation of the zirconium as a hydrous, zirconium oxide (usually retaining some sulphate) by the addition of a base and calcining the precipitated product. However, in practice it has been found that the precipitates formed in this manner are gel-like and difficult to filter.

These objects are achieved by a process for obtaining a hydrolyzed zirconium-containing precipitate from an aqueous zirconium sulphate solution, wherein said solution is combined with a solution of a base selected from ammonia, ammonium hydroxide and sodium hydroxide with thorough and continuous mixing in such a manner that the pH of the combined solutions is maintained at all times in the range 3 to 7, either by adding the solutions simultaneously to a suitable vessel or by mixing them together in a flowing stream, and collecting the precipitate which forms

According to present invention marble refers to a “calcium carbonate material”, it is intended to mean limestone, dolomite, or any other source of calcium carbonate conventionally used to make lime, cements, and the like. limestone is, of course, the most commonly used source of calcium carbonate for thermal insulation purposes.

The instant process requires the use of certain catalysts which are, in broadest outline, thermal reaction products of calcium carbonate and an alkali metal carbonate. These catalysts can be described as fused salts and have a vitreous nature. The calcium carbonate used to make the catalyst can be any calcium carbonate-containing material such as the limestone, dolomite or calcium carbonate per se. With respect to the alkali metal carbonates, illustrative examples are sodium carbonate, potassium carbonate,

Other materials such as granite, sand (Silica sand), Talc (Steatite, soap stone), Clays calcined and raw, Boron containing minerals, trap rock aggregate ordinarily used in concrete mixtures, compounds of Alumia and Silica ordinarily known as alumino silicates,

These materials are traditionally known as the thermal resistance properties, these properties are used to enhance the thermal resistance properties of the composition of the present invention.

According to present invention boron compounds such as boron nitrite or other salts which acts on the surface of the thermal insulation formed by the coating and depositing process is not smooth, but the bonding of the cementing provides the surface with smoothness, and the formation of the additional boron nitride coating thereon contributes to preventing the transmission of heat, the first thermal insulation layer formed by a material suitable for maintaining the temperature of the shielding layer below that at which creep of the shield material occurs or that at which thermally-induced changes in the physical properties of the shield material occurs

According to present invention that provides articles made of polymer-modified cement mortars and concretes and processes for the production thereof. The processes comprise curing compositions which contain hydraulic cement and aqueous dispersions of polymers or copolymers of methacrylic or acrylic acid esters by means of a two stage curing process the first stage of which is carried out at an elevated temperature under conditions of high humidity and the second stage of which is carried out under drying conditions, preferably at elevated temperatures

The exact details and possible variations of the above method are well known, but because of the complexity and therefore the cost of the method, the development and applications of polymer-impregnated concrete are more limited than they otherwise might have been.

Another method of modifying cement mortars and concretes is by the incorporation of polymers in the form of aqueous polymeric dispersions. Examples of such dispersions which have been described for this purpose include polyacrylate ester emulsions, ethylene/vinyl acetate emulsions and styrene/butadiene rubber latices. The aqueous polymeric dispersion is generally added to the cement and aggregate during mixing, and antifoaming agents are also frequently incorporated to control excessive air entrainment.

According to one aspect of the present invention, there is thus provided a process for the production of mortars and concretes which comprises curing a composition which contains hydraulic cement and an aqueous dispersion of a polymer or copolymer of a methacrylic or acrylic acid ester by means of a two stage curing process

According to present invention Products manufactured using cement aggregate consisting of Tiles, Blocks, Mortars, loose fill materials, paints and coatings, wall plasters, cement sheets, porous materials, joint fillers and additives.

According one of the aspects of the invention the method for manufacture of the composition of the invention is that homogeneous mixture of the premix of cement and other additive materials premixed and pulverized to uniform particle size ranging 0.001-0.01 mm, optionally the premix is suitably mixed with water to get concrete precasted articles or hydraulic cement mixture which may be grinded to uniform particle. The illustrative examples are as mentioned below,

The preferred embodiment is (1) Aggregate to be formed using 10 to 100% hydraulic white cement. The balance materials are the same as mentioned above. This mixture is hydrolyzed and allowed to set. The set mixture is crushed to form aggregate of varying grain sizes. This aggregate is used as one of the components of the final application mixture. The preferred embodiment is to use the aggregate as one of the components in a mixture of hydraulic white cement. The application mixture may contain 10% white cement and 10% to 90% aggregate (1). The balance material from list mentioned above.

### 1. Typical Example of the Hydraulic Cement Composition

| White Portland cement | 90-99.999 | w/w |
|---|---|---|
| Water | (as per requirement) | |
| Magnesia (MgO) or | 0.5-3.0% | w/w |
| Magnesium sulfate | | |
| Zirconium compounds, | 0.1-2.0 | w/w |
| Marble, | 0.1-5.0 | w/w |
| Dolomite, | 0.1-5.0 | w/w |
| Granite, | 0.1-5.0 | w/w |
| Sand (Silica sand), | 0.1-3.0 | w/w |
| Talc (Steatite, soap stone), | 0.1-5.0 | w/w |
| Clays calcined | 0.1-5.0 | w/w |
| Boron containing minerals, | 0.1-3.0 | w/w |
| Alumino silicates | 0.1-3.0 | w/w |
| Polymeric binder/s | 1.-3.0 | w/w |

### 2. Typical Example of the Non-Hydraulic Cement Composition (Premix)

| | | |
|---|---|---|
| White Portland cement | 90-99.999 | w/w |
| Magnesia (MgO) or | 0.5-3.0% | w/w |
| Magnesium sulfate | | |
| Zirconium compounds, | 0.1-2.0 | w/w |
| Marble, | 0.1-5.0 | w/w |
| Dolomite, | 0.1-5.0 | w/w |
| Granite, | 0.1-5.0 | w/w |
| Sand (Silica sand) | 0.1-3.0 | w/w |
| Talc (Steatite, soap stone), | 0.1-5.0 | w/w |
| Clays calcined | 0.1-5.0 | w/w |
| Boron containing minerals, | 0.1-3.0 | w/w |
| Alumino silicates | 0.1-3.0 | w/w |
| Polymeric binder/s | 1.0-3.0 | w/w |

1. Insulation and heat resistance hydraulic cement aggregates comprising of white Portland cement, with or without additives and fillers, magnesium oxide, zirconium compounds, marble, dolomite, granite, sand, talc, clays calcined, boron compounds, silicates, trap rock aggregate, polymeric binder/s optionally water.

2. Insulation and heat resistance hydraulic cement aggregates according to claim 1 wherein hydraulic cement is Portland cement, sulfate-resisting cement, blast furnace cement, pozzolanic cement, gray cement and other type of cement.

3. Insulation and heat resistance hydraulic cement aggregates according to claim 1 wherein zirconium compounds are zirconium sulfate, zirconium oxide.

4. Insulation and heat resistance hydraulic cement aggregates according to claim 1 wherein marble is calcium carbonate.

5. Insulation and heat resistance hydraulic cement aggregates according to claim 1 wherein dolomite is calcium magnesium carbonate.

6. Insulation and heat resistance hydraulic cement aggregates according to claim 1 wherein boron compounds are boron sulfate, boron trioxide, boron halide.

7. Insulation and heat resistance hydraulic cement aggregates according to claim 1 wherein silicates are alumino, calcium silicates,

8. Insulation and heat resistance hydraulic cement aggregates according to claim 1 wherein polymeric binders are polyacrylate ester emulsion, ethylene vinyl acetate, styrene, butadiene,

9. Insulation and heat resistance hydraulic cement aggregates according to claim 1 wherein hydraulic cement is 90-99.999 w/w.

10. Insulation and heat resistance hydraulic cement aggregates according to claim 1 wherein Magnesia (MgO) or magnesium sulfate is 0.5-3.0% w/w

11. Insulation and heat resistance hydraulic cement aggregates according to claim 1 wherein zirconium compounds is 0.1-2.0 w/w

12. Insulation and heat resistance hydraulic cement aggregates according to claim 1 wherein marble is 0.1-5.0 w/w

13. Insulation and heat resistance hydraulic cement aggregates according to claim 1 wherein dolomite is 0.1-5.0 w/w

14. Insulation and heat resistance hydraulic cement aggregates according to claim 1 wherein granite is 0.1-5.0 w/w

15. Insulation and heat resistance hydraulic cement aggregates according to claim 1 wherein sand (Silica sand) is 0.1-3.0 w/w

16. Insulation and heat resistance hydraulic cement aggregates according to claim 1 wherein talc is 0.1-5.0 w/w

17. Insulation and heat resistance hydraulic cement aggregates according to claim 1 wherein clays calcined is 0.1-5.0 w/w

18. Insulation and heat resistance hydraulic cement aggregates according to claim 1 wherein boron compounds are 0.1-3.0 w/w

19. Insulation and heat resistance hydraulic cement aggregates according to claim 1 wherein silicate is 0.1-3.0 w/w

20. Insulation and heat resistance hydraulic cement aggregates according to claim 1 wherein polymeric binder/s is 1.0-3.0 w/w

21. Insulation and heat resistance hydraulic cement aggregates according to claim 1 wherein Products manufactured are tiles, blocks, mortars, loose fill materials, paints and coatings, wall plasters, cement sheets, porous materials, joint fillers and additives
